(19) United States
(12) Patent Application Publication
(10) Pub. No.: US 2010/0077113 A1
(43) Pub. Date: Mar. 25, 2010

(54) DATA COMMUNICATION SYSTEM AND METHOD

(75) Inventors: Soon Jin CHOI, Suwon-si (KR); Seung Han Ko, Seongnam-si (KR); Bo II Seo, Gunpo-si (KR); Koon Shik Cho, Suwon-si (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon-si (KR)

(21) Appl. No.: 12/262,516

(22) Filed: Oct. 31, 2008

(30) Foreign Application Priority Data
Sep. 24, 2008 (KR) 10-2008-0093498

(51) Int. Cl. G06F 3/00

(52) U.S. Cl. 710/57

(57) ABSTRACT

Provided is a data communication system including a first-in first-out (FIFO) buffer having a fixed size; a central processing unit (CPU) that writes data stored in a memory into the FIFO buffer; a modem that reads the data written by the CPU from the FIFO buffer; and a modem controller that is connected to the FIFO buffer, the CPU, and the modem, respectively, and controls the CPU such that data having a larger volume than the size of the FIFO buffer can be processed.

### CROSS-REFERENCE TO RELATED APPLICATIONS

This application claims the benefit of Korean Patent Application No. 10-2008-0093498 filed with the Korea Intellectual Property Office on Sep. 24, 2008, the disclosure of which is incorporated herein by reference.

### BACKGROUND OF THE INVENTION

1. Field of the Invention

The present invention relates to a data communication system and method, and more specifically, to a data communication system and method, which can process a packet having a larger size that that of a first-in first-out (FIFO) buffer, while the fixed size of the FIFO is maintained.

2. Description of the Related Art

A packet in data communication means a bit group including data and a call control signal. In particular, when data is transmitted by a packet switching method, the data is disassembled into basic transmission units, and then transmitted. In a reception side, the data is assembled and processed.

In general, a packet has a size of 128 byte. However, the size of the packet may be changed into 52, 64, or 256 byte as a matter of convenience.

Since a packet in data communication has a predetermined size, a FIFO buffer which is designed in a hardware manner so as to process such a packet also has a predetermined size.

In some cases, however, a packet having a larger size than the predetermined size may be processed depending on the purpose of an application service. In this case, the FIFO buffer which is designed to process a packet having the predetermined size cannot be used. A new FIFO buffer should be designed.

Therefore, there is demand for a data communication system and method, which can process a packet having a size larger than a predetermined size by using the conventional FIFO buffer which is designed to process a packet having a predetermined size, depending on the purpose of an application service.

### SUMMARY OF THE INVENTION

An advantage of the present invention is that it provides a data communication system and method, which can process a packet having a larger size that that of a FIFO buffer, while the fixed size of the FIFO is maintained.

Additional aspect and advantages of the present general inventive concept will be set forth in part in the description which follows and, in part, will be obvious from the description, or may be learned by practice of the general inventive concept.

According to an aspect of the invention, a data communication system comprises a FIFO buffer having a fixed size; a central processing unit (CPU) that writes data stored in a memory into the FIFO buffer; a modem that reads the data written by the CPU from the FIFO buffer; and a modem controller that is connected to the FIFO buffer, the CPU, and the modem, respectively, and controls the CPU such that data having a larger volume than the size of the FIFO buffer can be processed.

The CPU which previously recognizes the size of the FIFO buffer may write data as much as the size of the FIFO buffer.

The modem controller may monitor the number of the data written into the FIFO buffer, and transmit a control signal to the CPU when a predetermined number of data remains in the FIFO buffer.

The modem controller may include a buffer counter which monitors the number of data written in the FIFO buffer.

According to another aspect of the invention, a data communication method comprises writing data into a FIFO buffer having a fixed size, as much as the size of the FIFO buffer; reading the data written into the FIFO buffer; monitoring the number of data remaining in the FIFO buffer; when a predetermined number of data remains in the FIFO buffer, transmitting a control signal to a CPU; and when the control signal is transmitted, resuming writing data into the FIFO buffer.

The data communication method may further comprise reading the data written into the FIFO buffer, after the transmitting of the control signal.

Data read after the transmitting of the control signal and data read before the transmitting of the control signal may be recognized as one packet.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a data communication system according to an embodiment of the present invention; and

FIG. 2 is a flow chart showing a data communication method according to an embodiment of the invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures. In the drawings, like reference numerals will be attached to the same components, and the duplicated descriptions thereof will be omitted.

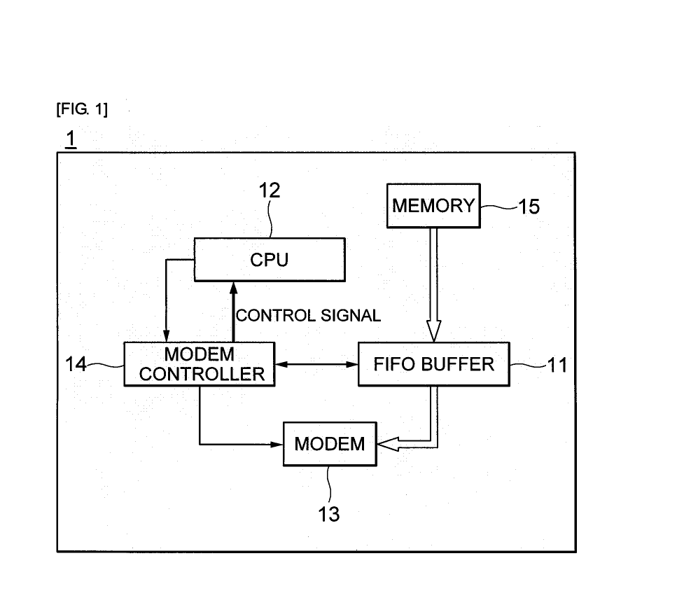

FIG. 1 is a block diagram of a data communication system according to an embodiment of the present invention.

Referring to FIG. 1, the data communication system 1 according to the embodiment of the invention includes a first-in first-out (FIFO) buffer 11, a central processing unit (CPU) 12, a modem 13, and a modem controller 14.

The FIFO buffer 11 is designed in a hardware manner, and has a fixed size. The FIFO buffer 11 receives data stored in a memory 15, and then transmits the received data to the modem controller 14.

The CPU 12 can write the data stored in the memory 15 into the FIFO buffer 11. In this case, the CPU 12 recognizes the size of the FIFO buffer 11 and the size of data to transmit, that is, a packet.

The modem 13 can read the data written into the FIFO buffer 11. In this case, the modem 13 informs the modem controller 14 that the data entered the FIFO buffer 11, and then starts to read the data.

The modem controller 14 is connected to the FIFO buffer 11, the CPU 12, and the modem 13, respectively, and can control the CPU 12 such that data having a larger volume than the size of the FIFO buffer 11 can be processed.

The modem controller 14 monitors the number of data written into the FIFO buffer 11, and transmits a control signal to the CPU 12 when a predetermined number of data remain in the FIFO buffer 11.

The modem controller 14 may include a buffer counter. The buffer counter may serve to monitor the number of data written into the FIFO buffer 11.

In general, the speed at which the CPU 12 writes data into the FIFO buffer 11 is higher than the speed at which the modem 13 read data from the FIFO buffer 11. In this case, when the size of data is larger than the size of the FIFO buffer 11, and if the modem 13 starts to read the data after the CPU 12 writes all the data, the FIFO buffer 11 may overflow, so that an error occurs.

Therefore, when data is written into the FIFO buffer 11, the modem 13 immediately starts to read the data, and the modem controller 14 monitors the number of the data of the FIFO buffer 11. In this case, when a predetermined number of data remains, the modem controller 14 transmits a control signal to the CPU 12. When the control signal is transmitted, the CPU 12 writes the other data into the FIFO buffer 11. In this way, the data having a larger volume than the size of the FIFO buffer 11 can be processed.

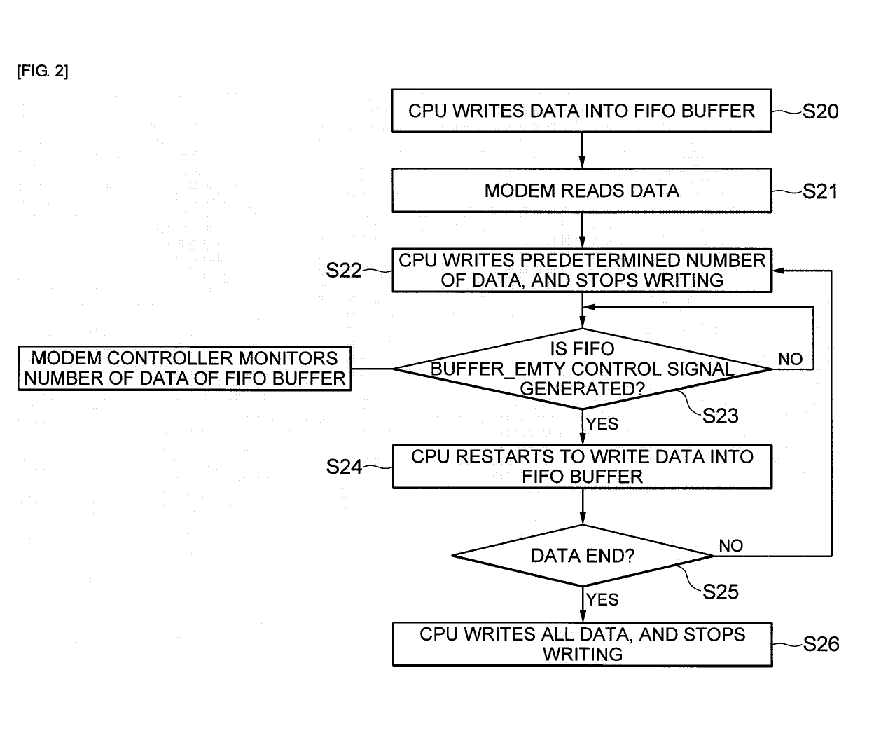

FIG. 2 is a flow chart showing a data communication method according to an embodiment of the invention.

Referring to FIG. 2, the CPU 12 starts to write data into the FIFO buffer 11 (step S20). At this time, since the CPU 12 already recognizes the size of the FIFO buffer 11, the CPU 12 writes data as much as the size of the FIFO buffer 11, and then stops writing (step S22).

The modem 13 transmits to the modem controller 14 a signal indicating that the data was written into the FIFO buffer 11, and immediately starts to read the data (step S21). The modem controller 14 continuously monitors the number of data of the FIFO buffer 11. When a predetermined number of data remains in the FIFO buffer 11, the modem controller 14 transmits a control signal to the CPU 12 (step S23).

The CPU 12 receives the controls signal, and then starts to write data (step S24). At this time, since the CPU 12 recognizes the size of the data, the CPU 12 writes all the data, and then stops writing (step S26). However, when the size of the remaining data is larger than the size of the FIFO buffer 11, the CPU 12 stops writing, and waits for a control signal.

Therefore, although the fixed size of the FIFO buffer 11 is maintained, it is possible to process a packet having a larger size than that of the FIFO buffer 11.

According to the present invention, while the fixed size of the FIFO buffer is maintained, a packet having a lager size than that of the FIFO buffer can be processed. Therefore, it is possible to perform a streaming service.

Further, when the packet size increases, the throughput of the service increases. Accordingly, it is possible to provide a high-quality service.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A data communication system comprising:
a first-in first-out (FIFO) buffer having a fixed size;
a central processing unit (CPU) that writes data stored in a memory into the FIFO buffer;
a modem that reads the data written by the CPU from the FIFO buffer; and
a modem controller that is connected to the FIFO buffer, the CPU, and the modem, respectively, and controls the CPU such that data having a larger volume than the size of the FIFO buffer can be processed.

2. The data communication system according to claim 1, wherein the CPU which previously recognizes the size of the FIFO buffer writes data as much as the size of the FIFO buffer.

3. The data communication system according to claim 1, wherein the modem controller monitors the number of the data written into the FIFO buffer, and transmits a control signal to the CPU when a predetermined number of data remains in the FIFO buffer.

4. The data communication system according to claim 1, wherein the modem controller includes a buffer counter which monitors the number of data written in the FIFO buffer.

5. A data communication method comprising:
writing data into a FIFO buffer having a fixed size, as much as the size of the FIFO buffer;
reading the data written into the FIFO buffer;
monitoring the number of data remaining in the FIFO buffer;
when a predetermined number of data remains in the FIFO buffer, transmitting a control signal to a CPU; and
when the control signal is transmitted, resuming writing data into the FIFO buffer.

6. The data communication system according to claim 5 further comprising:
reading the data written into the FIFO buffer, after the transmitting of the control signal.

7. The data communication system according to claim 6, wherein data read after the transmitting of the control signal and data read before the transmitting of the control signal are recognized as one packet.
